(19) United States
(12) Patent Application Publication
(10) Pub. No.: US 2013/0174795 A1
(43) Pub. Date: Jul. 11, 2013

(54) CANINE DIRECTIONAL COMMAND SYSTEM

(71) Applicant: Andrew Fannon Lamkin, Albuquerque, NM (US)

(72) Inventor: Andrew Fannon Lamkin, Albuquerque, NM (US)

(73) Assignee: Honeywell International Inc.

(21) Appl. No.: 13/348,396

(22) Filed: Jan. 11, 2012

(51) Int. Cl. A01K 15/02; A01K 27/00

(52) U.S. Cl. 119/720; 119/859

(57) ABSTRACT

A canine directional command system includes a directional command collar assembly configured for releasable securement around the neck of a canine. The collar assembly includes a plurality of command stimulation units, preferably including three vibration command stimulation units, and one combination vibration/electrical command stimulation unit. The collar assembly is positioned on the neck of a canine so that the stimulation units are respectively positioned at the front, rear, left, and right areas of the neck of the canine. A wireless transmitter of the command system permits selective operation of the stimulation units of the collar assembly, thereby permitting a handler of the canine to provide directional commands and signals to the canine, without resort to verbal or visual commands.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

The present invention relates generally to a wireless canine command system, and more particularly to a wireless command system for canines which permits selective input of directional commands to the canine.

### BACKGROUND

So-called working dogs, including military and special service dogs require a reliable, collar-based system to facilitate command, direction, and control of dogs by a handler. A typical command set for military and special service dogs includes the following commands, including visual commands: arm forward to move forward; arm left to search left; arm right to search right; arm back to return to handler; and wireless of control of electrical stimulation (shock) on the collar to command the dog to lay down in place.

As will be appreciated, dog handlers frequently find themselves in situations where the dog can no longer see the handler directly. In such instances, none of the above-noted visual directional commands can be used, and the handler must try to control the dog by electrical stimulation to command the dog to stay in place, and thereby permit the handler to locate the dog.

The present disclosure is directed to an improved canine command system which permits a handler to wirelessly provide directional commands to a working or service dog, thus facilitating control, direction, and command of the dog even if visual contact with the animal is not possible.

### SUMMARY

In accordance with the present disclosure, a canine directional command system is configured to permit enhanced control, direction, and command of working and service dogs, including military and special service dogs used in the military and combat environments. The present command system permits directional signals and commands to be wirelessly directed to the working dog, without reliance upon the usual hand or verbal commands. The present system greatly enhances command and control of working dogs, since the dog can be maintained under the desired control and supervision, without the dog having direct visual contact with the dog handler.

A canine directional command system embodying the principles of the present disclosure includes a directional command collar assembly configured for releasable securement around the neck of a canine. The command collar assembly comprises a flexible collar sized for securement around the neck of the canine in a relatively fixed orientation on the neck. The command collar assembly includes a plurality of independently operable command stimulation units mounted on the flexible collar in spaced apart relationship to administer stimulation to spaced apart areas of the neck of the canine. In the illustrated embodiment, the command collar assembly includes four command stimulation units, with the collar assembly being positionable on the neck of the canine so that the four command stimulation units are respectively positioned at the front, rear, left, and right areas of the neck of the canine.

The command collar assembly further includes a wireless receiver mounted on the flexible collar which is operatively connected to the command stimulation units. The collar assembly includes a battery for operation of the assembly, including the receiver and stimulation units. In the illustrated form, the collar assembly includes three vibration command stimulation units, and one combination vibration/electrical command stimulation unit. The system is operable such that when the command collar assembly is fitted to the canine, the vibration command stimulation units are respectively positioned at the left, rear, and right areas of the canine's neck. The combination vibration/electrical command stimulation unit is positionable at the front of the canine's neck. This is consistent with current practice, by which electrical stimulation (shock) is typically administered to a working canine at the front area of the neck.

The present command system further includes a wireless transmitter for use by a handler of the canine. The transmitter includes at least one selectively operable command input device such as in the form of a spring-loaded switch, whereby the handler can operate the transmitter to independently operate a selected one of the command stimulation units of the command collar assembly, to thereby command, direct, and control the actions of the canine. In the illustrated form, the transmitter includes at least four selectively operable input devices for respectively operating the four stimulation units of the command collar assembly. In the illustrated embodiment, the wireless transmitter includes a fifth input device which is selectively operable to operate the combination vibration/electrical command stimulation unit on the command collar assembly to provide electrical stimulation to the canine.

Other features and advantages of the present disclosure will become readily apparent from the following detailed description, the accompanying drawings, and the appended claims.

### BRIEF DESCRIPTION OF THE DRAWINGS

FIG. 1 is an illustration of a working dog, such as a military or service canine, with a directional command collar assembly of the present canine directional command system shown fitted to the neck of the dog;

FIG. 2 is a perspective view of the directional command collar assembly of the present system;

FIG. 2a is a relatively enlarged, perspective view of a command stimulation unit of the present collar assembly;

FIG. 3 is a diagrammatic view of the directional command collar assembly of the present system; and

FIG. 4 is a top plan view of a wireless transmitter of the present canine directional command system.

### DETAILED DESCRIPTION

While the present system is susceptible of embodiment in various forms, there is shown in the drawings and will hereinafter be described one specific embodiment, with the understanding that the present disclosure is to be considered as an exemplification of the present system, and is not intended to limit the disclosure to the specific embodiment illustrated and described herein.

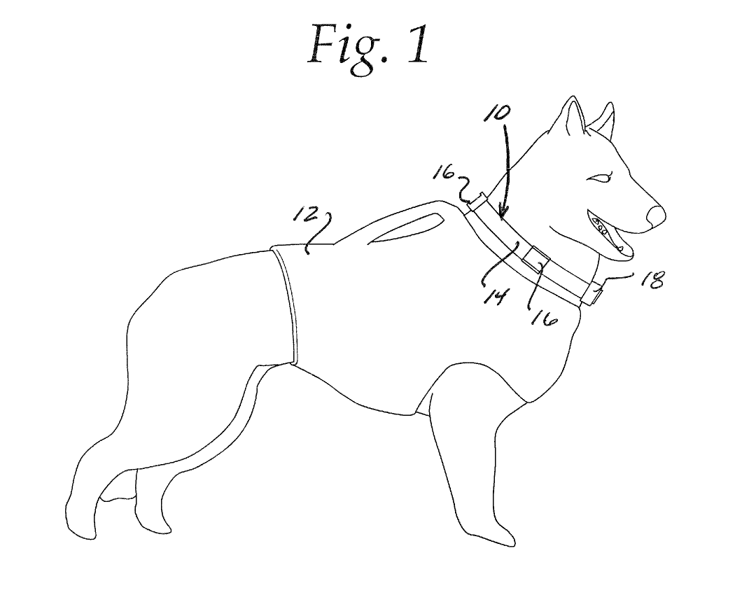

With reference first to FIG. 1, therein is illustrated a working dog having a directional command collar assembly 10 of the present system releasably secured to the dog's neck. For military service, a working dog may be fitted with a protective garment 12.

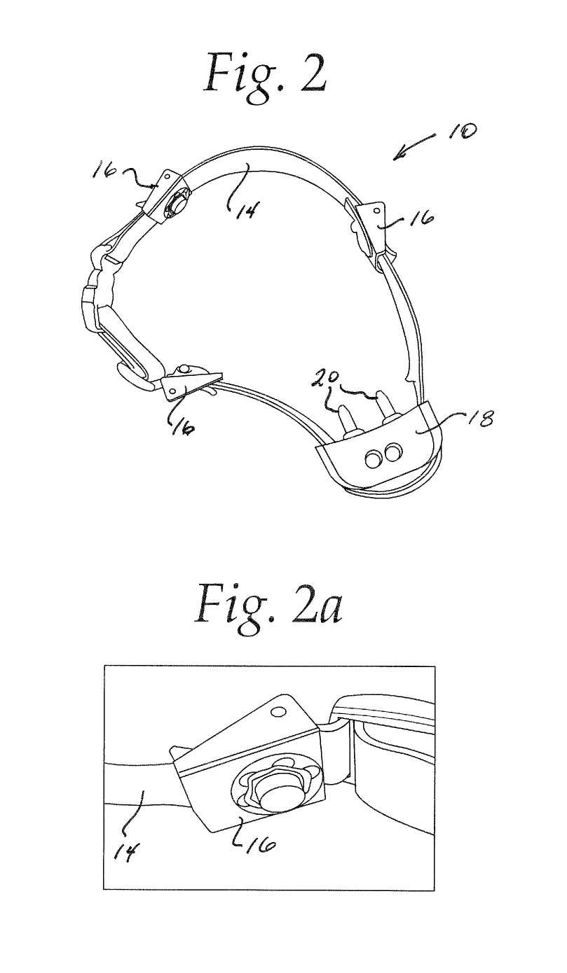

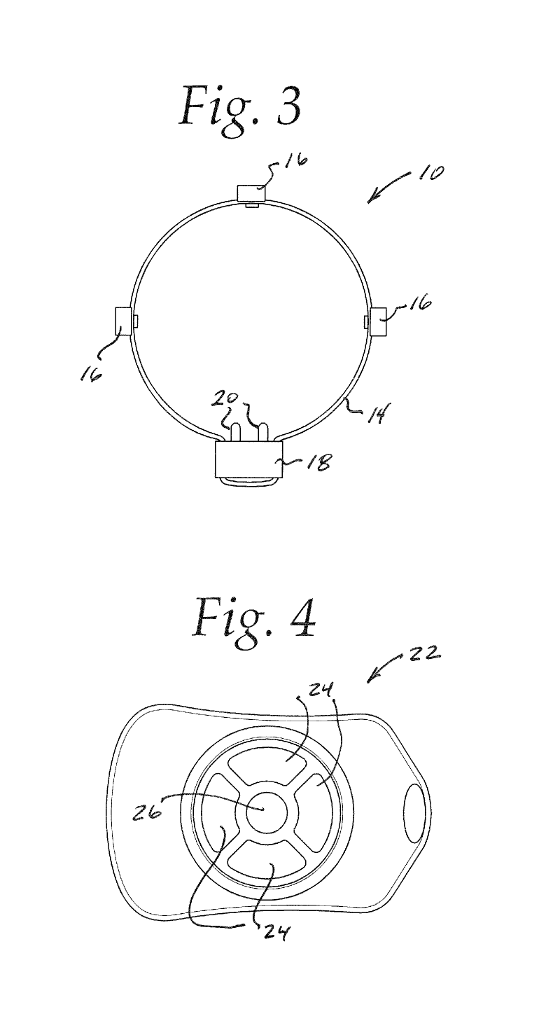

FIG. 2 further illustrates the directional command collar assembly 10 of the present command system. The command collar assembly 10 includes a flexible collar 14 sized for securement around the neck of the canine in a relatively fixed orientation on the neck. Securement in a relatively fixed orientation ensures that directional commands given to the dog, by stimulation units on the collar assembly, are properly understood by the animal.

The present system contemplates that directional commands to the working dog are provided by a combination of vibrational and electrical stimulation. To this end, the command collar assembly includes a plurality of independently operable command stimulation units mounted on the flexible collar 14 in spaced apart relationship to administer stimulation to spaced apart areas of the neck of the canine. In accordance with the illustrated embodiment, the command collar assembly includes at least three independently operable command stimulation units, with a current embodiment including three vibration command stimulation units, and a combination vibration/electrical command stimulation unit.

In the illustrated embodiment, the command collar assembly 10 includes three vibration command stimulation units 16. The vibration command stimulation units are positioned on the flexible collar 14, such that when the control collar assembly is positioned on the neck of a canine, the vibration command stimulation units 16 are respectively positioned at the left, rear, and right areas of the neck of the canine.

In contrast, a fourth stimulation unit 18 is positionable at the front area of the neck of the canine, and comprises a combination vibration/electrical command stimulation unit. As will be further described, this combination stimulation unit can be selectively operated to provide either vibrational stimulation or electrical stimulation to the front area of the neck of the canine.

In accordance with the illustrated embodiment, the combination stimulation unit 18 preferably includes a wireless receiver and associated battery, integrated into the combination unit 18. Each of the stimulation units is operatively connected with the wireless receiver by suitable wiring integrated into the flexible collar 14 of the collar assembly 10.

The collar assembly 10 is preferably adjustable for size to fit on the necks of differently sized canines. In the illustrated form, each of the vibration command stimulation units 16 is adjustably positionable, by a suitable cam-lock mechanism, along the length of the flexible collar 14. This facilitates the respective positioning of the command stimulation units at the front, rear, left, and right areas of the necks of differently sized canines.

Each of the vibration command stimulation units includes a suitable vibration-inducing mechanism, such as a piezo-electric device, which a canine to which the collar assembly is fitted can readily discern in a directional fashion at the right, left, front, and rear areas of the canine's neck. The combination stimulation unit 18 includes a pair of spaced apart electrodes 20 for administering electrical stimulation to the front area of the canine's neck.

FIG. 4 illustrates the wireless transmitter 22 of the present directional command system. While it is presently contemplated that the wireless transmitter comprise a radio frequency transmitter, and that the wireless receiver of the command collar assembly 10 comprises a radio frequency receiver, it is within the purview of the present invention that alternative wireless operative connection between the receiver and transmitter can be employed.

As illustrated in FIG. 4, the wireless transmitter 22 includes at least one, and preferably a plurality, of selectively operable command input devices for selective operation of the command stimulation units of the command collar assembly 10. In particular, the wireless transmitter 22 includes four spaced apart input devices 24, such as in the form of spring-loaded buttons or switches, which are positioned on the wireless transmitter to correspondingly provide stimulation to the right, left, front, and rear areas of the canine's neck, by the stimulation units of the command collar assembly. It is presently contemplated that each of input devices 24 are operable to provide vibrational stimulation to the respective areas of the canine's neck.

The wireless transmitter 22 can further include another selectively operable input device, such as centrally positioned input device 26, which is selectively operable to operate the combination vibration/electrical command stimulation 18 to provide electrical stimulation to the front area of the canine's neck. This is consistent with current wireless command systems for canines, which typically are configured to provide electrical stimulation to the front area of the canine's neck for direction and control.

From the foregoing, operation and use of the present system will be readily appreciated. The command collar assembly of the present system is releasably secured around the neck of the working canine, with the collar assembly adjusted so that it remains in a relatively fixed orientation on the neck of the canine. One or more adjustment mechanisms of the collar assembly permit it to be fitted to a canine, with the combination stimulation unit 18 fitted at the front area of the neck, with the electrodes 20 positioned to provide the intended electrical stimulation to the front area of the canine's neck. The adjustable positioning of the vibration command stimulation units 16 along the flexible collar 14 permit each of these stimulation units to be respectively positioned at the left, rear, and right areas of the canine's neck.

Directional command and control of the canine is now possible by a handler by selective operation of the wireless transmitter 22. By selective operation of the input devices 24, 26, the handler can easily direct and signal the canine to follow directional commands, including left, right, etc. Activation of combination stimulation unit 18 by selective operation of input device 26 provides electrical stimulation to the front area of the canine's neck, instructing the canine to stay in place, consistent with conventional training.

As will be appreciated, the present system provides reliable and versatile direction, command, and signalling of a canine by a handler without reliance upon typical visual or verbal commands. As such, the present system is suitable for use in many different dog-handling applications requiring directions by the handler to direct the dog to specific areas or the like. Such applications include handling of military, police, hunting, and special service dogs.

Although certain embodiments discussed herein have been described in detail above, other modifications are possible. Other steps may be provided, or steps may be eliminated, from those described above, and other components may be added to or removed from, the described system. Other embodiments may be within the scope of the following claims.

1. A canine directional command system, comprising:
a directional command collar assembly configured for releasable securement around the neck of a canine,
said command collar assembly comprising a flexible collar sized for securement around the neck of the canine in a relatively fixed orientation on the neck,
a plurality of independently operable command stimulation units mounted on said flexible collar in spaced apart relationship to administer stimulation to spaced apart areas of the neck of the canine, and
a wireless receiver mounted on said flexible collar and operatively connected to said command stimulation units; and
a wireless transmitter for use by a handler of the canine, the transmitter including at least one selectively operable command input device, whereby the handler can operate said transmitter to independently operate a selected one of said command stimulation units of said command collar assembly to control the actions of the canine.

2. A canine directional command system in accordance with claim 1, wherein said command collar assembly includes at least three of said independently operable command stimulation units.

3. A canine directional command system in accordance with claim 2, wherein said command collar includes four of said command stimulation units positioned in spaced apart relationship on said flexible collar, said command collar assembly being positionable on the neck of said canine so that said four command stimulation units are respectively positioned at the front, rear, left, and right areas of the neck of the canine.

4. A canine directional command system in accordance with claim 1, wherein said command stimulation units comprise vibration command stimulation units.

5. A canine directional command system in accordance with claim 3, wherein said one of said stimulation units positionable on the front neck area of the canine comprises a combination vibration/electrical command stimulation unit.

6. A canine directional command system in accordance with claim 3, wherein said four command stimulation units are adjustably positionable on said flexible collar to facilitate respective positioning of said command stimulation units at the front, rear, left and right areas of the necks of differently sized canines.

7. A canine directional command system in accordance with claim 3, wherein said wireless transmitter includes at least four selectively operable input devices for respectively operating said four command stimulation units of said command collar assembly.

8. A canine directional command system, comprising:
a directional command collar assembly configured for releasable securement around the neck of a canine,
said command collar assembly comprising a flexible collar sized for securement around the neck of the canine in a relatively fixed orientation on the neck,
a plurality of independently operable, command stimulation units mounted on said flexible collar in spaced apart relationship, including four of said command stimulation units positioned in spaced apart relationship on said flexible collar, said command collar assembly being positionable on the neck of said canine so that said four command stimulation units are respectively positioned at the front, rear, left, and right areas of the neck of the canine, and
a wireless receiver mounted on said flexible collar and operatively connected to said command stimulation units; and
a wireless transmitter for use by a handler of the canine, the transmitter including at least four selectively operable input devices for respectively operating said four stimulation units of said command collar assembly, whereby the handler can operate said transmitter to independently operate a selected one of said stimulation units on of said command collar assembly to control the actions of the canine.

9. A canine directional command system in accordance with claim 8, wherein said command stimulation units comprise vibration command stimulation units.

10. A canine directional command system in accordance with claim 9, wherein said one of said command stimulation units positionable on the front neck area of the canine comprises a combination vibration/electrical command stimulation unit.

11. A canine directional command system in accordance with claim 9, wherein said wireless transmitter includes a selectively operable input device for operating the said combination vibration/electrical command stimulation unit to provide electrical stimulation.

12. A canine directional command system in accordance with claim 8, wherein said four stimulation units are adjustably positionable on said flexible collar to facilitate respective positioning of said stimulation units at the front, rear, left and right areas of the necks of differently sized canines.

13. A canine directional command system in accordance with claim 8, wherein said wireless receiver comprises a radio frequency receiver, and said wireless transmitter comprised a radio frequency transmitter.

14. A canine directional command system in accordance with claim 8, wherein said command collar assembly includes a battery.
